(19) United States
(12) Patent Application Publication
(10) Pub. No.: US 2024/0048988 A1
(43) Pub. Date: Feb. 8, 2024

(54) ROBUSTNESS OF ARTIFICIAL INTELLIGENCE OR MACHINE LEARNING CAPABILITIES AGAINST COMPROMISED INPUT

(71) Applicant: Nokia Technologies Oy, Espoo (FI)

(72) Inventors: Rakshesh PRAVINCHANDRA BHATT, Bangalore (IN); Chaitanya AGGARWAL, Munich (DE); Ranganathan MAVUREDDI DHANASEKARAN, Munich (DE); Saurabh KHARE, Bangalore (IN)

(21) Appl. No.: 18/363,380

(22) Filed: Aug. 1, 2023

(30) Foreign Application Priority Data
Aug. 5, 2022 (IN) 202241044885

(51) Int. Cl. H04W 12/12; H04L 9/40

(52) U.S. Cl. CPC H04W 12/12; H04L 63/1441; H04L 63/1416

(57) ABSTRACT

There are provided measures for improved robustness of artificial intelligence or machine learning capabilities against compromised input. Such measures exemplarily comprise receiving, from a first machine learning model training data collection entity, first machine learning model training input data, analyzing said first machine learning model training input data for malicious input detection, deducing, based on a result of said analyzing, whether said first machine learning model training data collection entity is suspected to be compromised, and transmitting, if said first machine learning model training data collection entity is suspected to be compromised, information to a core network entity indicative of that said first machine learning model training data collection entity is suspected to be compromised.

### FIELD

Various example embodiments relate to improved robustness of artificial intelligence or machine learning capabilities against compromised input. More specifically, various example embodiments exemplarily relate to measures (including methods, apparatuses and computer program products) for realizing improved robustness of artificial intelligence or machine learning capabilities against compromised input.

### BACKGROUND

The present specification generally relates to networks, more particularly mobile networks or cellular networks, providing and/or utilizing artificial intelligence (AI)/machine learning (ML) capabilities.

In present mobile networks or cellular networks, AI/ML algorithms are applied to be used for various network optimizations.

Such network optimizations include, for example, network energy saving, load balancing, and mobility optimization.

Network energy saving is an important use case which may involve different layers of the network, with mechanisms operating at different time scales. Cell activation/deactivation is an energy saving scheme in the spatial domain that exploits traffic offloading in a layered structure to reduce the energy consumption of the whole radio access network (RAN). When the expected traffic volume is lower than a fixed threshold, the cells may be switched off, and the served user equipments (UE) may be offloaded to a new target cell. Efficient energy consumption can also be achieved by other means such as reduction of load, coverage modification, or other RAN configuration adjustments. The optimal energy saving decision depends on many factors including the load situation at different RAN nodes, RAN nodes capabilities, key performance indicator (KPI)/quality of service (QoS) requirements, number of active UEs, UE mobility, cell utilization, etc.

The objective of load balancing is to distribute load evenly among cells and among areas of cells, or to transfer part of the traffic from congested cells or from congested areas of cells, or to offload users from one cell, cell area, carrier, or radio access technology (RAT) to improve network performance. This can be done by means of optimization of handover parameters and handover actions. The automation of such optimization can provide high quality user experience, while simultaneously improving the system capacity and also to minimize human intervention in the network management and optimization tasks.

Mobility optimization is a scheme to guarantee service-continuity during the mobility by minimizing the call drops, radio link failures (RLF), unnecessary handovers, and handover ping-pong. For the applications characterized with the stringent QoS requirements such as reliability, latency etc., the quality of experience (QoE) is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packet-drop-intolerant and low-latency applications. In addition, the effectiveness of adjustment based on feedback may be weak due to randomness and inconstancy of transmission environment.

One property of such AI/ML algorithms is that data received/retrieved from various network entities is utilized by the AI/ML algorithms. In particular, different inputs from UEs (like RLF reports, minimization of drive tests (MDT) reports, etc.) can be consumed by various AI/ML algorithms.

The various network entities include, for example, UEs (e.g. terminals), which are out of access by network operators or network infrastructure equipment producers.

Currently, due to provisioning of UEs to actively contribute to the AI/ML operations, various attack scenarios can be envisioned especially when the involved UEs are compromised.

For instance,
a set of compromised UEs can send false or manipulated data to the AI/ML model training function to skew the performance,
compromised UEs—if involved in federated learning (FL)—can also provide false hyperparameters during the local training phase, which can then also affect the overall performance and accuracy during the model aggregation phase.

While UE abnormal behavior may be detected, no mechanism to detect compromised UEs which are attacking the AI/ML services using false/manipulated training data or hyperparameters exists.

However, if any of the involved UEs is compromised, it is likely that this compromised UEs' inputs negatively impact the AI/ML algorithms, and, subsequently, affect the automated network optimizations that rely on these algorithms.

Such compromised UEs may impact, for example
energy saving strategy, such as recommended cell activation/deactivation,
handover strategy, including recommended candidate cells for taking over the traffic,
predicted energy efficiency, and
predicted energy state (e.g., active, high, low, inactive).

Hence, the problem arises that mobile networks or cellular networks utilizing AI/ML algorithms for various network optimizations are vulnerable with respect to compromised network entities' inputs and in particular with respect to (the inputs of) compromised UEs.

Hence, there is a need to provide for improved robustness of artificial intelligence or machine learning capabilities against compromised input.

### SUMMARY

Various example embodiments aim at addressing at least part of the above issues and/or problems and drawbacks.

Various aspects of example embodiments are set out in the appended claims.

According to an exemplary aspect, there is provided a method of a radio access network entity, the method comprising receiving, from a first machine learning model training data collection entity, first machine learning model training input data, analyzing said first machine learning model training input data for malicious input detection, deducing, based on a result of said analyzing, whether said first machine learning model training data collection entity is suspected to be compromised, and transmitting, if said first machine learning model training data collection entity is suspected to be compromised, information to a core network entity indicative of that said first machine learning model training data collection entity is suspected to be compromised.

According to an exemplary aspect, there is provided a method of a core network entity, the method comprising receiving, from a first radio access network entity, information indicative of that a first machine learning model training data collection entity is suspected to be compromised, receiving information indicative of that said first machine learning model training data collection entity is handed over towards a second radio access network entity, and transmitting, to said second radio access network entity, information indicative of that said first machine learning model training data collection entity is suspected to be compromised.

According to an exemplary aspect, there is provided a method of a machine learning model training entity, the method comprising receiving, from a plurality of machine learning model training data collection entities, machine learning model training input data and/or machine learning model hyperparameter data, transmitting, towards an analytics service provider entity, a subscription request for malicious input detection analysis results, receiving, from said analytics service provider entity, a subscription request for machine learning model training related information, and transmitting, towards said analytics service provider entity, said machine learning model training related information.

According to an exemplary aspect, there is provided a method of an analytics service provider entity, the method comprising receiving, from a machine learning model training entity, a subscription request for malicious input detection analysis results, transmitting, to said machine learning model training entity, a subscription request for machine learning model training related information, and receiving, from said machine learning model training entity, said machine learning model training related information.

According to an exemplary aspect, there is provided an apparatus of a radio access network entity, the apparatus comprising receiving circuitry configured to receive, from a first machine learning model training data collection entity, first machine learning model training input data, analyzing circuitry configured to analyze said first machine learning model training input data for malicious input detection, deducing circuitry configured to deduce, based on a result of said analyzing, whether said first machine learning model training data collection entity is suspected to be compromised, and transmitting circuitry configured to transmit, if said first machine learning model training data collection entity is suspected to be compromised, information to a core network entity indicative of that said first machine learning model training data collection entity is suspected to be compromised.

According to an exemplary aspect, there is provided an apparatus of a core network entity, the apparatus comprising receiving circuitry configured to receive, from a first radio access network entity, information indicative of that a first machine learning model training data collection entity is suspected to be compromised, and to receive information indicative of that said first machine learning model training data collection entity is handed over towards a second radio access network entity, and transmitting circuitry configured to transmit, to said second radio access network entity, information indicative of that said first machine learning model training data collection entity is suspected to be compromised.

According to an exemplary aspect, there is provided an apparatus of a machine learning model training entity, the apparatus comprising receiving circuitry configured to receive, from a plurality of machine learning model training data collection entities, machine learning model training input data and/or machine learning model hyperparameter data, and transmitting circuitry configured to transmit, towards an analytics service provider entity, a subscription request for malicious input detection analysis results, wherein said receiving circuitry is configured to receive, from said analytics service provider entity, a subscription request for machine learning model training related information, and said transmitting circuitry is configured to transmit, towards said analytics service provider entity, said machine learning model training related information.

According to an exemplary aspect, there is provided an apparatus of an analytics service provider entity, the apparatus comprising receiving circuitry configured to receive, from a machine learning model training entity, a subscription request for malicious input detection analysis results, and transmitting circuitry configured to transmit, to said machine learning model training entity, a subscription request for machine learning model training related information, wherein said receiving circuitry is configured to receive, from said machine learning model training entity, said machine learning model training related information.

According to an exemplary aspect, there is provided an apparatus of a radio access network entity, the apparatus comprising at least one processor, at least one memory including computer program code, and at least one interface configured for communication with at least another apparatus, the at least one processor, with the at least one memory and the computer program code, being configured to cause the apparatus to perform receiving, from a first machine learning model training data collection entity, first machine learning model training input data, analyzing said first machine learning model training input data for malicious input detection, deducing, based on a result of said analyzing, whether said first machine learning model training data collection entity is suspected to be compromised, and transmitting, if said first machine learning model training data collection entity is suspected to be compromised, information to a core network entity indicative of that said first machine learning model training data collection entity is suspected to be compromised.

According to an exemplary aspect, there is provided an apparatus of a core network entity, the apparatus comprising at least one processor, at least one memory including computer program code, and at least one interface configured for communication with at least another apparatus, the at least one processor, with the at least one memory and the computer program code, being configured to cause the apparatus to perform receiving, from a first radio access network entity, information indicative of that a first machine learning model training data collection entity is suspected to be compromised, receiving information indicative of that said first machine learning model training data collection entity is handed over towards a second radio access network entity, and transmitting, to said second radio access network entity, information indicative of that said first machine learning model training data collection entity is suspected to be compromised.

According to an exemplary aspect, there is provided an apparatus of a machine learning model training entity, the apparatus comprising at least one processor, at least one memory including computer program code, and at least one interface configured for communication with at least another apparatus, the at least one processor, with the at least one memory and the computer program code, being configured to cause the apparatus to perform receiving, from a plurality of machine learning model training data collection entities, machine learning model training input data and/or machine learning model hyperparameter data, transmitting, towards an analytics service provider entity, a subscription request for malicious input detection analysis results, receiving, from said analytics service provider entity, a subscription request for machine learning model training related information, and transmitting, towards said analytics service provider entity, said machine learning model training related information.

According to an exemplary aspect, there is provided an apparatus of an analytics service provider entity, the apparatus comprising at least one processor, at least one memory including computer program code, and at least one interface configured for communication with at least another apparatus, the at least one processor, with the at least one memory and the computer program code, being configured to cause the apparatus to perform receiving, from a machine learning model training entity, a subscription request for malicious input detection analysis results, transmitting, to said machine learning model training entity, a subscription request for machine learning model training related information, and receiving, from said machine learning model training entity, said machine learning model training related information.

According to an exemplary aspect, there is provided an apparatus comprising means for performing the method according to any one of the aforementioned method-related exemplary aspects of the present disclosure.

According to an exemplary aspect, there is provided a computer program comprising instructions, which, when executed by an apparatus, cause the apparatus to perform the method according to any one of the aforementioned method-related exemplary aspects of the present disclosure.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables efficient countermeasures against inputs of compromised network entities', their influence on such AI/ML algorithms utilized in (e.g.) mobile/cellular networks, and their influence on network optimizations utilizing such AI/ML algorithms, to thereby solve at least part of the problems and drawbacks identified in relation to the prior art.

By way of example embodiments, there is provided improved robustness of artificial intelligence or machine learning capabilities against compromised input. More specifically, by way of example embodiments, there are provided measures and mechanisms for realizing improved robustness of artificial intelligence or machine learning capabilities against compromised input.

Thus, improvement is achieved by methods, apparatuses and computer program products enabling/realizing improved robustness of artificial intelligence or machine learning capabilities against compromised input.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a block diagram illustrating an apparatus according to example embodiments,

FIG. 7 is a schematic diagram of a procedure according to example embodiments,

FIG. 8 is a schematic diagram of a procedure according to example embodiments,

FIG. 9 is a schematic diagram of a procedure according to example embodiments,

FIG. 10 is a schematic diagram of a procedure according to example embodiments,

FIG. 11 (FIGS. 11 (a), 11 (b), and 11 (c)) shows a schematic diagram of signaling sequences according to example embodiments,

FIG. 12 shows a schematic diagram of signaling sequences according to example embodiments, and

FIG. 13 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) improved robustness of artificial intelligence or machine learning capabilities against compromised input.

Data collection as referred to herein means a function that provides input data to AI/ML model training and AI/ML model inference functions. AI/ML algorithm specific data preparation (e.g., data pre-processing and cleaning, formatting, and transformation) is not carried out in the data collection function.

Examples of input data may include measurements from UEs or different network entities, feedback from an actor, output from an AI/ML model:
Training data: Data needed as input for the AI/ML model training function,
Inference data: Data needed as input for the AI/ML model inference function.

Model training as referred to herein means a function that performs the AI/ML model training, validation, and testing which may generate model performance metrics as part of the model testing procedure. The model training function is also responsible for data preparation (e.g., data pre-processing and cleaning, formatting, and transformation) based on training data delivered by a data collection function, if required. Model deployment/update is used to initially deploy a trained, validated, and tested AI/ML model to the model inference function or to deliver an updated model to the model inference function.

Model inference as referred to herein means a function that provides AI/ML model inference output (e.g., predictions or decisions). A model inference function may provide model performance feedback to a model training function when applicable. The model inference function is also responsible for data preparation (e.g., data pre-processing and cleaning, formatting, and transformation) based on inference data delivered by a data collection function, if required. An output of a model inference function is the inference output of the AI/ML model produced by a model inference function. Model performance feedback may be used for monitoring the performance of the AI/ML model, when available.

Actor as referred to herein means a function that receives the output from the model inference function and triggers or performs corresponding actions. The actor may trigger actions directed to other entities or to itself. Feedback from an actor is information that may be needed to derive training data, inference data or to monitor the performance of the AI/ML model and its impact to the network through updating of KPIs and performance counters.

Hyperparameters (model hyperparameters) as referred to herein mean a configuration that is external to the model and whose value cannot be estimated from data.

Hyperparameters are often used in processes to help estimate model parameters. Hyperparameters are often specified by the practitioner. Hyperparameters can often be set using heuristics. Hyperparameters are often tuned for a given predictive modeling problem.

As mentioned above, mobile/cellular networks utilizing AI/ML algorithms for various network optimizations are vulnerable with respect to compromised network entities' inputs and in particular with respect to (the inputs of) compromised UEs, as, dependent on the utilization of the inputs and the deviated network optimizations and the respective use cases, these potentially malicious inputs may have substantial impacts on the network operation.

This may even be amplified in view of the RAN's ability to share (compromised) UE information with each other, i.e., among entities of the RAN. For example, the RAN does not understand the subscription permanent identifier (SUPI) as a UE identity. The RAN just knows context (next generation (NG) context), and context to SUPI mapping is available only in the access and mobility management function (AMF).

Therefore, as a concrete example, if a gNB1 detects a UE with an identifier “NG Context-1” as not behaving correctly or as being compromised, then this “NG Context-1” has no meaning in the other gNBs, which, consequently cannot identify the UE being the source of potentially malicious information as a UE detected as not behaving correctly or as being compromised.

As a further concrete example, if the UE is identified as malicious UE at a gNB1, then the UE detaches and attaches back again at gNB2, then for gNB2, this is a fresh UE and previous analysis from gNB1 (including its identification as being malicious) will be lost.

Hence, in brief, according to example embodiments, measures to detect inputs received from compromised UEs towards AI/ML algorithms being used for various network optimizations is provided.

In particular, according to example embodiments, anomaly detection is applied during the pre-processing of data received by AI/ML algorithms.

This measure can detect clear outliers from the input data and eliminate the possible bias of input data in the pre-processing phase of AI/ML algorithms.

Further, according to example embodiments, the data received from UEs in similar locations are statistically correlated to detect slow biases from compromised UEs.

Namely, it is likely that compromised UEs intend to introduce slow biases in the input data consumed by AI/ML algorithms. Such slow biases can be difficult to detect and can affect the AI/ML based network optimizations. According to example embodiments, this measure, i.e., comparing the statistics of the input data received from various UEs in similar locations can help to identify such slow drifts in the data.

Further, according to example embodiments, for model trainings happening on multiple RAN nodes for the same network optimization, or for model trainings happening on a RAN Node and an operations, administration and maintenance (OAM) node for the same network optimization, the analysis done according to measures steps mentioned above (anomaly detection during pre-processing, statistical correlation) can be shared between the entities performing model trainings.

According to example embodiments, further, information on malicious UE behavior (e.g. specific to a particular model or particular analytics (e.g. “model X”/“analytics X”)) is shared to other network nodes, in particular other gNBs.

As a concrete example, when a gNB1 detects that the UE (context ID) is malicious, the gNB1 informs the AMF thereof. According to example embodiments, the AMF identifies the SUPI and marks the corresponding UE Context that the UE is not behaving correctly for the particular model or particular analytics (e.g. “model X”/“analytics X”).

Alternatively, according to example embodiments, the AMF obtains this information about the malicious UE from a network data analytics function (NWDAF) or the OAM for the particular model or particular analytics (e.g. “model X”/“analytics X”).

As a result, according to example embodiments, during the handover or UE attach phase, the AMF notifies the other gNB (to which the UE is handed over or to which the UE is attached) that this UE (UE Context) should not be considered for the particular model or particular analytics (e.g. “model X”/“analytics X”).

Example embodiments are specified below in more detail.

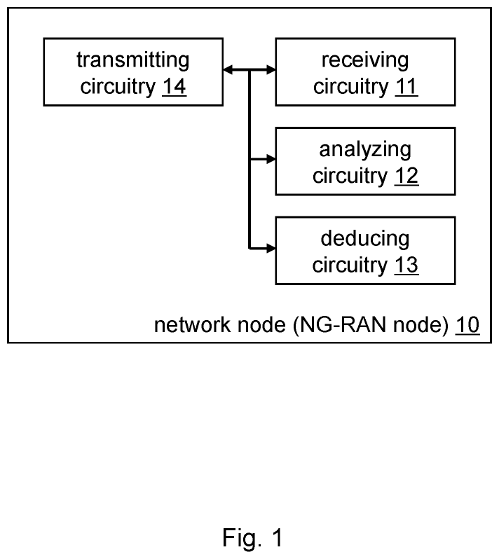

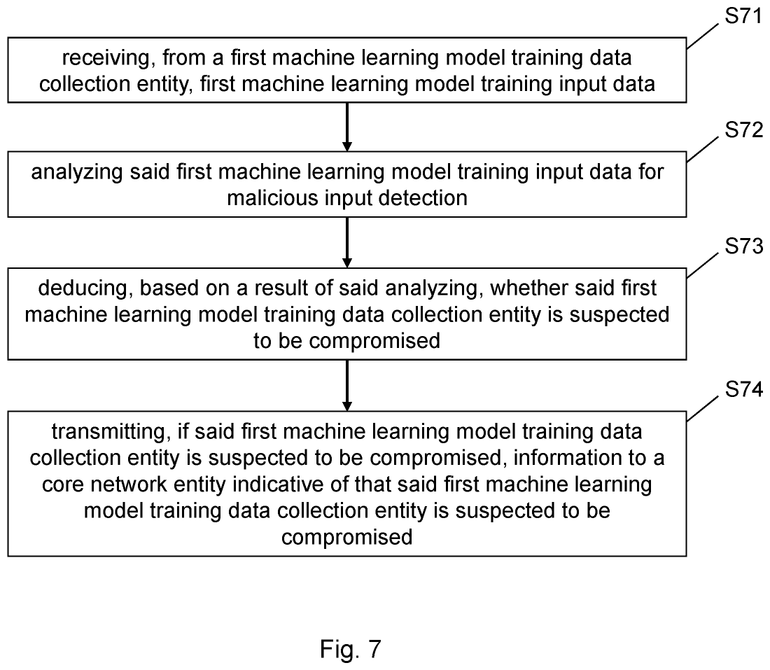

FIG. 1 is a block diagram illustrating an apparatus according to example embodiments. The apparatus may be a network node or entity 10 such as a next generation radio access network (NG-RAN) node (or a node or entity providing such functionality) comprising a receiving circuitry 11, an analyzing circuitry 12, a deducing circuitry 13, and a transmitting circuitry 14. The receiving circuitry 11 receives, from a first machine learning model training data collection entity, first machine learning model training input data. The analyzing circuitry 12 analyzes said first machine learning model training input data for malicious input detection. The deducing circuitry 13 deduces, based on a result of said analyzing circuitry, whether said first machine learning model training data collection entity is suspected to be compromised. The transmitting circuitry 14 transmits, if said first machine learning model training data collection entity is suspected to be compromised, information to a core network entity indicative of that said first machine learning model training data collection entity is suspected to be compromised. FIG. 7 is a schematic diagram of a procedure according to example embodiments. The apparatus according to FIG. 1 may perform the method of FIG. 7 but is not limited to this method. The method of FIG. 7 may be performed by the apparatus of FIG. 1 but is not limited to being performed by this apparatus.

As shown in FIG. 7, a procedure according to example embodiments comprises an operation of receiving (S71), from a first machine learning model training data collection entity, first machine learning model training input data, an operation of analyzing (S72) said first machine learning model training input data for malicious input detection, an operation of deducing (S73), based on a result of said analyzing, whether said first machine learning model training data collection entity is suspected to be compromised, and an operation of transmitting (S74), if said first machine learning model training data collection entity is suspected to be compromised, information to a core network entity indicative of that said first machine learning model training data collection entity is suspected to be compromised.

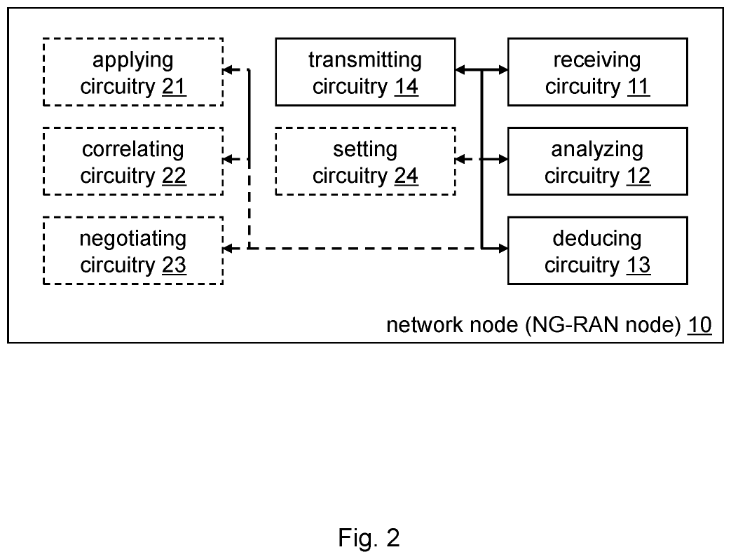

FIG. 2 is a block diagram illustrating an apparatus according to example embodiments. In particular, FIG. 2 illustrates a variation of the apparatus shown in FIG. 1. The apparatus according to FIG. 2 may thus further comprise an applying circuitry 21, a correlating circuitry 22, a negotiating circuitry 23, and/or a setting circuitry 24.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 7, exemplary details of the analyzing operation (S72) are given, which are inherently independent from each other as such. Such exemplary analyzing operation (S72) according to example embodiments may comprise an operation of applying an anomaly detection during machine learning model training data pre-processing of said first machine learning model training input data.

According to a variation of the procedure shown in FIG. 7, exemplary additional operations are given, which are inherently independent from each other as such. According to such variation, an exemplary method according to example embodiments may comprise an operation of receiving, from at least one second machine learning model training data collection entity, second machine learning model training input data.

According to a variation of the procedure shown in FIG. 7, exemplary details of the analyzing operation (S72) are given, which are inherently independent from each other as such. Such exemplary analyzing operation (S72) according to example embodiments may comprise an operation of statistically correlating said first machine learning model training input data with said second machine learning model training input data to detect biases in said first machine learning model training input data.

According to a variation of the procedure shown in FIG. 7, exemplary additional operations are given, which are inherently independent from each other as such.

According to such variation, an exemplary method according to example embodiments may comprise an operation of negotiating a handover decision for a third second machine learning model training data collection entity towards said radio access network entity, an operation of receiving, from said core network entity, information indicative of that said third machine learning model training data collection entity is suspected to be compromised, and an operation of setting to ignore third machine learning model training input data from said third machine learning model training data collection entity.

According to further example embodiments, said machine learning model training data collection entity comprises a user equipment, is a user equipment, or is comprised in a user equipment.

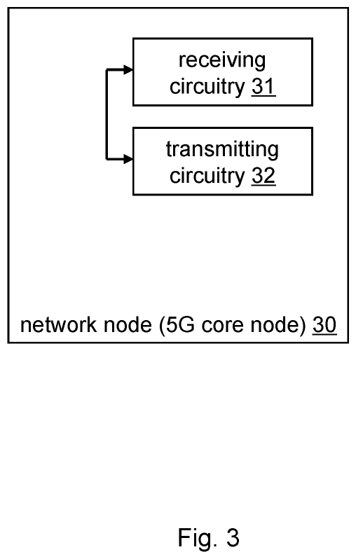

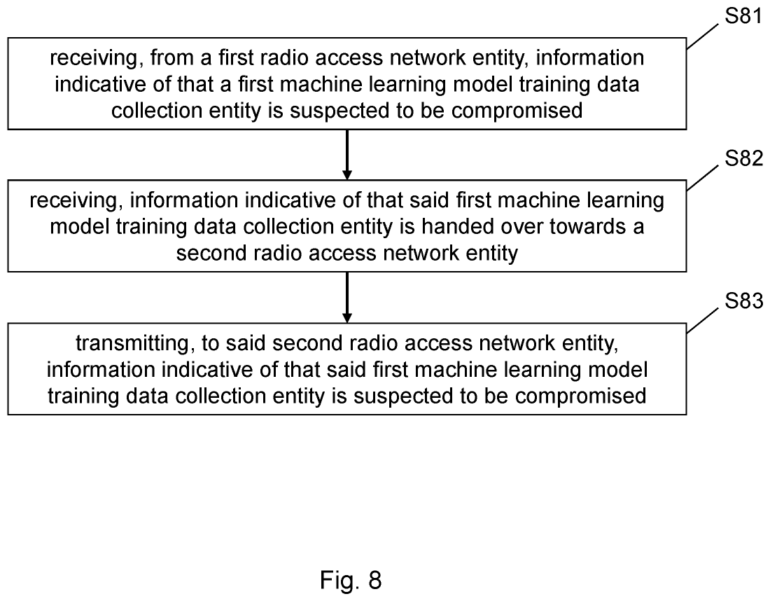

FIG. 3 is a block diagram illustrating an apparatus according to example embodiments. The apparatus may be a network node or entity 30 such as a 5^{th} Generation (5G) core node (or a node or entity providing such functionality) comprising a receiving circuitry 31 and a transmitting circuitry 32. The receiving circuitry 31 receives, from a first radio access network entity, information indicative of that a first machine learning model training data collection entity is suspected to be compromised. The receiving circuitry 31 further receives information indicative of that said first machine learning model training data collection entity is handed over towards a second radio access network entity. The transmitting circuitry 32 transmits, to said second radio access network entity, information indicative of that said first machine learning model training data collection entity is suspected to be compromised. FIG. 8 is a schematic diagram of a procedure according to example embodiments. The apparatus according to FIG. 3 may perform the method of FIG. 8 but is not limited to this method. The method of FIG. 8 may be performed by the apparatus of FIG. 3 but is not limited to being performed by this apparatus.

As shown in FIG. 8, a procedure according to example embodiments comprises an operation of receiving (S81), from a first radio access network entity, information indicative of that a first machine learning model training data collection entity is suspected to be compromised, an operation of receiving (S82), information indicative of that said first machine learning model training data collection entity is handed over towards a second radio access network entity, and an operation of transmitting (S83), to said second radio access network entity, information indicative of that said first machine learning model training data collection entity is suspected to be compromised.

In an embodiment at least some of the functionalities of the apparatus shown in FIG. 3 may be shared between two physically separate devices forming one operational entity. Therefore, the apparatus may be seen to depict the operational entity comprising one or more physically separate devices for executing at least some of the described processes.

According to a variation of the procedure shown in FIG. 8, exemplary additional operations are given, which are inherently independent from each other as such. According to such variation, an exemplary method according to example embodiments may comprise an operation of transmitting, towards a data storage entity, said information indicative of that said first machine learning model training data collection entity is suspected to be compromised.

According to a variation of the procedure shown in FIG. 8, exemplary additional operations are given, which are inherently independent from each other as such. According to such variation, an exemplary method according to example embodiments may comprise an operation of transmitting, towards a data analytics entity, a request to obtain an updated confidence value for said first machine learning model training data collection entity, and an operation of receiving, from said data analytics entity, said updated confidence value for said first machine learning model training data collection entity.

According to further example embodiments, said first machine learning model training data collection entity comprises a user equipment, is a user equipment, or is comprised in a user equipment.

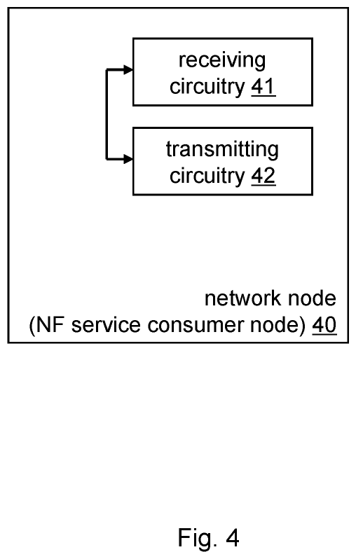

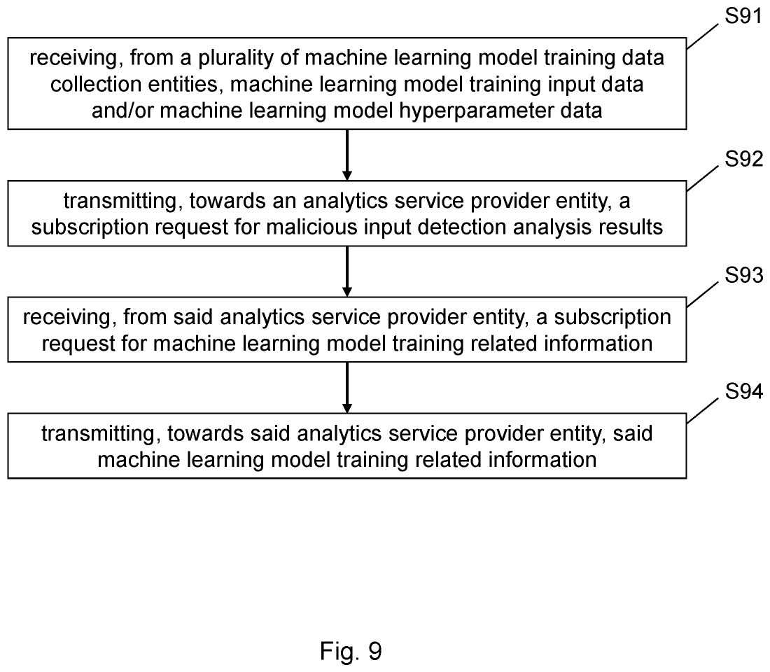

FIG. 4 is a block diagram illustrating an apparatus according to example embodiments. The apparatus may be a network node or entity 40 such as a network function (NF) service consumer node (or a node or entity providing such functionality) comprising a receiving circuitry 41 and a transmitting circuitry 42. The receiving circuitry 41 receives, from a plurality of machine learning model training data collection entities, machine learning model training input data and/or machine learning model hyperparameter data. The transmitting circuitry 42 transmits, towards an analytics service provider entity, a subscription request for malicious input detection analysis results. The receiving circuitry 41 receives, from said analytics service provider entity, a subscription request for machine learning model training related information. The transmitting circuitry 42 transmits, towards said analytics service provider entity, said machine learning model training related information. FIG. 9 is a schematic diagram of a procedure according to example embodiments. The apparatus according to FIG. 4 may perform the method of FIG. 9 but is not limited to this method. The method of FIG. 9 may be performed by the apparatus of FIG. 4 but is not limited to being performed by this apparatus.

As shown in FIG. 9, a procedure according to example embodiments comprises an operation of receiving (S91), from a plurality of machine learning model training data collection entities, machine learning model training input data and/or machine learning model hyperparameter data, an operation of transmitting (S92), towards an analytics service provider entity, a subscription request for malicious input detection analysis results, an operation of receiving (S93), from said analytics service provider entity, a subscription request for machine learning model training related information, and an operation of transmitting (S94), towards said analytics service provider entity, said machine learning model training related information.

In an embodiment at least some of the functionalities of the apparatus shown in FIG. 4 may be shared between two physically separate devices forming one operational entity.

Therefore, the apparatus may be seen to depict the operational entity comprising one or more physically separate devices for executing at least some of the described processes.

According to further example embodiments, said machine learning model training related information includes at least one of
a machine learning model accuracy,
identifiers of said plurality of machine learning model training data collection entities,
said machine learning model training input data and/or machine learning model hyperparameter data, and
cluster information on a cluster formed by said plurality of machine learning model training data collection entities for federated learning.

According to a variation of the procedure shown in FIG. 9, exemplary additional operations are given, which are inherently independent from each other as such.

According to such variation, an exemplary method according to example embodiments may comprise an operation of receiving, from said analytics service provider entity, said malicious input detection analysis results.

According to further example embodiments, said malicious input detection analysis results include at least one of
machine learning model training data collection entities out of said plurality of machine learning model training data collection entities which are suspected to be compromised, and
a mitigation suggestion.

According to further example embodiments, said machine learning model training data collection entity comprises a user equipment, is a user equipment, or is comprised in a user equipment.

According to further example embodiments, said machine learning model training entity comprises a network function service consumer, is a network function service consumer, or is comprised in a network function service consumer.

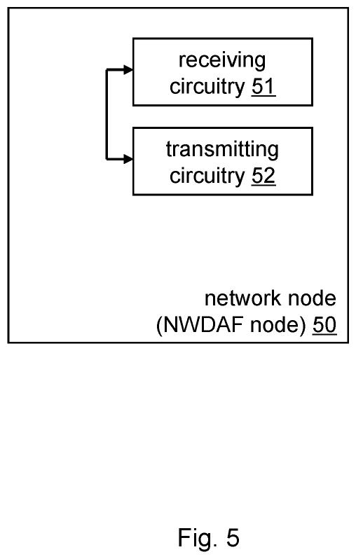

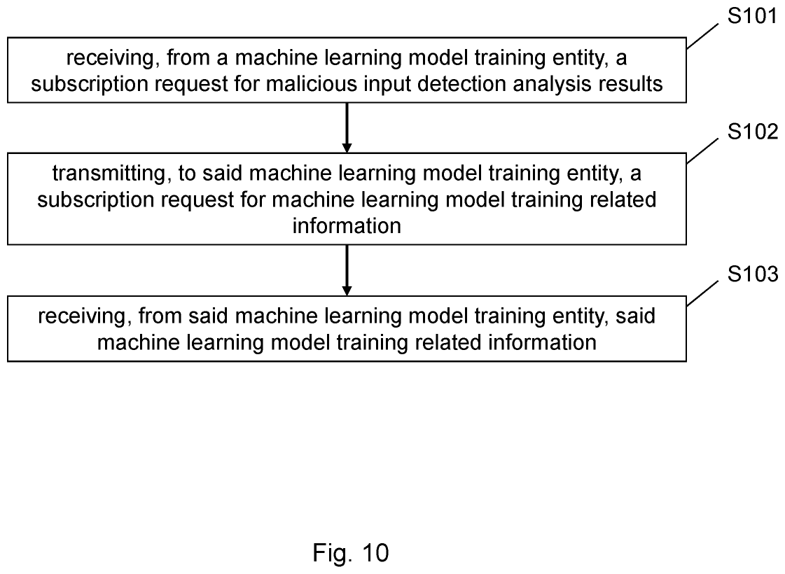

FIG. 5 is a block diagram illustrating an apparatus according to example embodiments. The apparatus may be a network node or entity 50 such as a network data analytics function (NWDAF) node (or a node or entity providing such functionality) comprising a receiving circuitry 51 and a transmitting circuitry 52. The receiving circuitry 51 receives, from a machine learning model training entity, a subscription request for malicious input detection analysis results. The transmitting circuitry 52 transmits, to said machine learning model training entity, a subscription request for machine learning model training related information. The receiving circuitry 51 receives, from said machine learning model training entity, said machine learning model training related information. FIG. 10 is a schematic diagram of a procedure according to example embodiments. The apparatus according to FIG. 5 may perform the method of FIG. 10 but is not limited to this method. The method of FIG. 10 may be performed by the apparatus of FIG. 5 but is not limited to being performed by this apparatus.

As shown in FIG. 10, a procedure according to example embodiments comprises an operation of receiving (S101), from a machine learning model training entity, a subscription request for malicious input detection analysis results, an operation of transmitting (S102), to said machine learning model training entity, a subscription request for machine learning model training related information, and an operation of receiving (S103), from said machine learning model training entity, said machine learning model training related information.

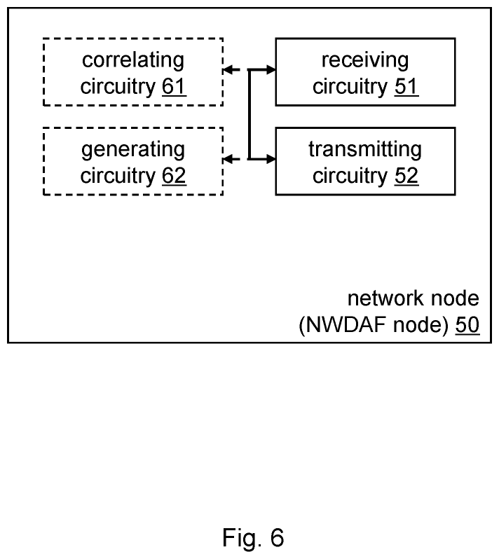

FIG. 6 is a block diagram illustrating an apparatus according to example embodiments. In particular, FIG. 6 illustrates a variation of the apparatus shown in FIG. 5. The apparatus according to FIG. 6 may thus further comprise a correlating circuitry 61 and/or a generating circuitry 62.

In an embodiment at least some of the functionalities of the apparatus shown in FIG. 5 (or 6) may be shared between two physically separate devices forming one operational entity. Therefore, the apparatus may be seen to depict the operational entity comprising one or more physically separate devices for executing at least some of the described processes.

According to further example embodiments, said machine learning model training related information includes at least one of
a machine learning model accuracy,
identifiers of a plurality of machine learning model training data collection entities providing machine learning model training input data and/or machine learning model hyperparameter data to said machine learning model training entity,
said machine learning model training input data and/or machine learning model hyperparameter data, and
cluster information on a cluster formed by said plurality of machine learning model training data collection entities for federated learning.

According to a variation of the procedure shown in FIG. 10, exemplary additional operations are given, which are inherently independent from each other as such. According to such variation, an exemplary method according to example embodiments may comprise an operation of statistically correlating said machine learning model training input data and/or machine learning model hyperparameter data to detect deviations in said machine learning model training input data and/or machine learning model hyperparameter data.

According to a variation of the procedure shown in FIG. 10, exemplary additional operations are given, which are inherently independent from each other as such. According to such variation, an exemplary method according to example embodiments may comprise an operation of generating, based on said correlating, said malicious input detection analysis results, and an operation of transmitting, to said machine learning model training entity, said malicious input detection analysis results.

According to further example embodiments, said malicious input detection analysis results include at least one of
machine learning model training data collection entities out of said plurality of machine learning model training data collection entities which are suspected to be compromised, and
a mitigation suggestion.

According to a variation of the procedure shown in FIG. 10, exemplary additional operations are given, which are inherently independent from each other as such. According to such variation, an exemplary method according to example embodiments may comprise an operation of transmitting, to a federated learning server entity, a request for at least one cluster identifier corresponding to at least one identifier of a machine learning model training data collection entity of said plurality of machine learning model training data collection entities, and an operation of receiving, from said federated learning server entity, said at least one cluster identifier.

According to further example embodiments, said machine learning model training entity comprises a user equipment, is a user equipment, or is comprised in a user equipment.

According to further example embodiments, said analytics service provider entity comprises a network data analytics function, is a network data analytics function, or is comprised in a network data analytics function.

Example embodiments outlined and specified above are explained below in more specific terms.

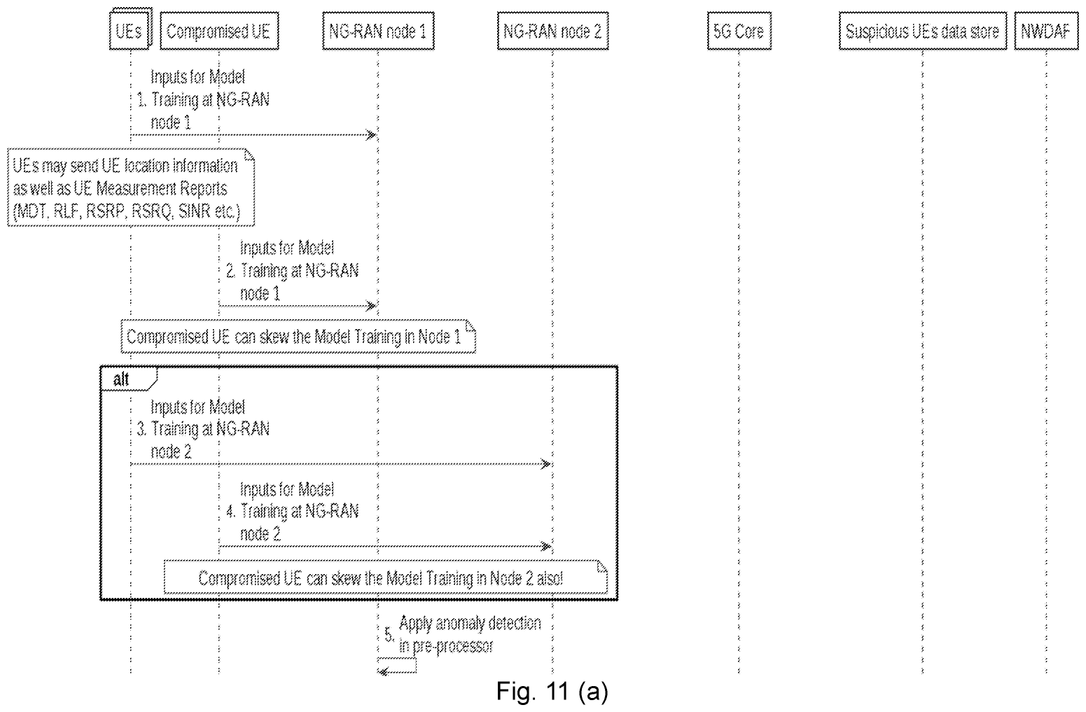

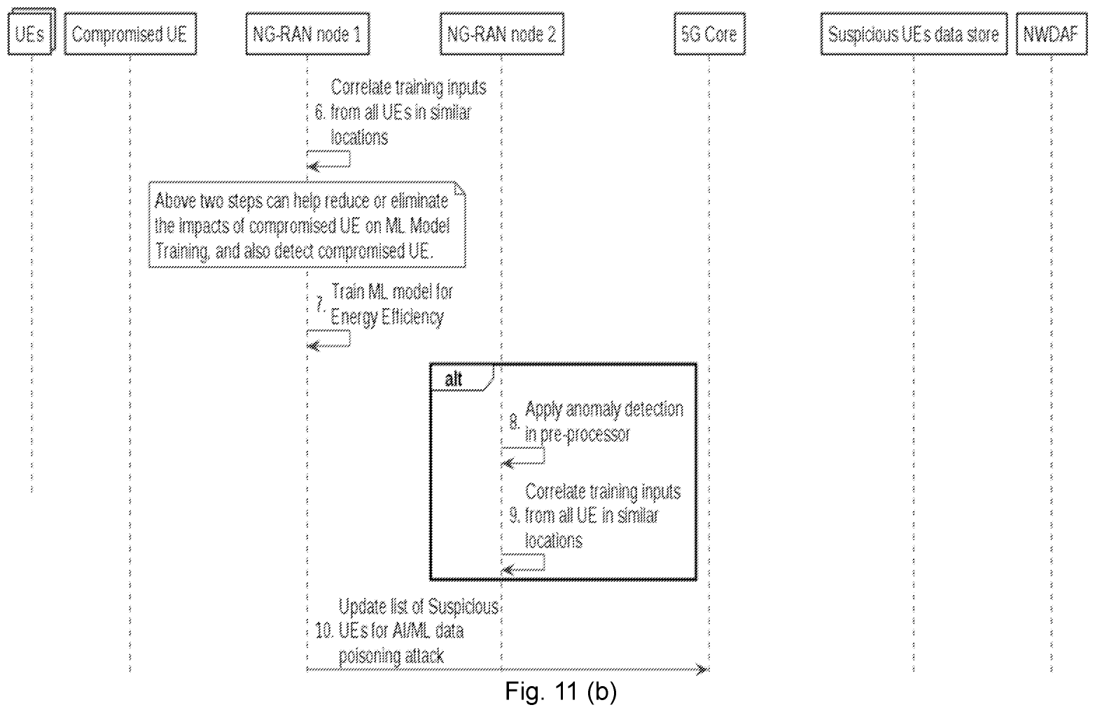

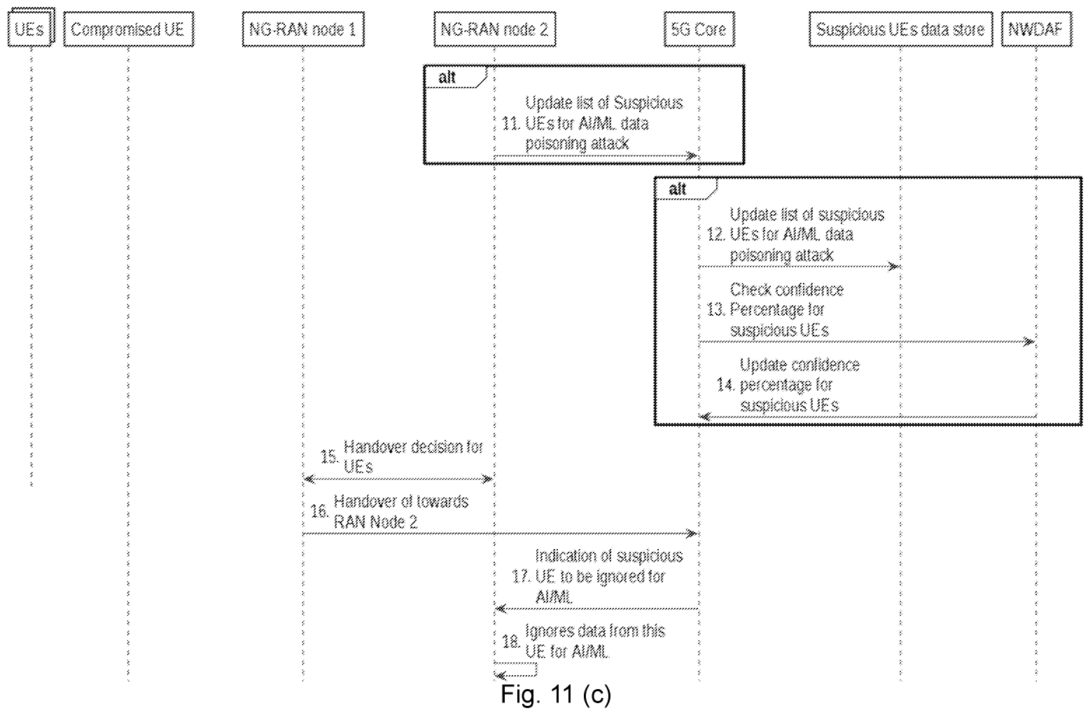

FIG. 11 (FIGS. 11 (a), 11 (b), and 11 (c)) shows a schematic diagram of signaling sequences according to example embodiments, and in particular illustrates an overview of a RAN procedure according to example embodiments for the energy saving example. Here, FIG. 11 (b) is a continuation of FIG. 11 (a), and FIG. 11 (c) is a continuation of FIG. 11 (b).

In FIG. 11, “Compromised UE” is the UE which is already being attacked and compromised by the attacker.

The intention of this compromised UE is to send corrupted model training data to both NG-RANs, which could result in corruption of the models in the NG-RANs. “NG-RAN node 1” and “NG-RAN node 2” are assumed to have the AI/ML model training functionality.

In a step 1 of FIG. 11, “normal” UEs share the inputs for the model training to NG-RAN node 1. The UEs could send the measurement reports with reference signal received power (RSRP) measurement, reference signal received quality (RSRQ) measurement, signal-to-noise and interference ratio (SINR) measurement, etc. or raw location co-ordinates, serving cell ID, moving velocity in UE location information message or MDT measurements, radio resource management (RRM) measurements.

In a step 2 of FIG. 11, the compromised UEs could send the corrupted model training to NG-RAN node 1, which could result in corrupting the Model training in Node 1.

In a step 3 of FIG. 11, the normal UEs share the inputs for the model training to the NG-RAN node 2.

In a step 4 of FIG. 11, the compromised UEs could send the corrupted model training to NG-RAN node 2, which could result in corrupting the Model training in Node 2.

In a step 5 of FIG. 11, according to example embodiments, the NG-RAN node 1 applies anomaly detection in the data pre-processor. According to example embodiments, this measure can eliminate the clear outliers and prevent those from impacting the AI/ML model training.

In a step 6 of FIG. 11, according to example embodiments, the NG-RAN node 1 correlates training inputs from all UEs in similar locations. This step also includes statistically correlating the input data received from various UEs in similar locations, and detecting possible slow drifts in data that may be introduced by compromised UEs.

According to example embodiments, the measures of steps 5 and 6 of FIG. 11 help to reduce or eliminate the impacts of compromised UEs on ML model training and also detect the compromised UEs (potentially isolate them for further message exchange). According to example embodiments, this information is used to isolate compromised UEs and to reduce system level impacts due to such UEs.

In a step 7 of FIG. 11, the NG-RAN node 1 trains the ML model for (according to the exemplary use case) energy efficiency (other models may also be trained depending on use-case, for example for load balancing, mobility optimizations).

In steps 8 and 9 of FIG. 11, according to example embodiments, the NG-RAN node 2 repeats the steps 5 and 6 similar to NG RAN node 1, if the model training is also implemented in NG-RAN node 2.

In a step 10 of FIG. 11, according to example embodiments, the NG-RAN node 1 updates/notifies the 5GC (e.g. AMF) about detected UEs which are suspicious to be compromised, and, are potential sources of data poisoning attacks.

In a step 11 of FIG. 11, according to example embodiments, other NG-RAN nodes (like NG-RAN node 2 illustrated in FIG. 11), which also detect compromised UEs, update/notify 5GC about detected UEs which are suspicious to be compromised, and, are potential sources of data poisoning attacks.

In a step 12 of FIG. 11, according to example embodiments, the 5GC maintains a common repository with a list of suspicious UEs posing threat to AI/ML models.

In steps 13 and 14 of FIG. 11, according to example embodiments, the 5GC may also check with NWDAF or management data analytics service (MDAS) to obtain an updated confidence percentage for suspicious UEs. According to example embodiments, this can then be used to isolate malicious UEs from the network, depending upon the confidence percentage.

In a step 15 of FIG. 11, in some use-cases like energy saving, the inference of AI/ML algorithms may lead to a handover decision made between NG-RAN node 1 and node 2 for some UEs. The handover decision may also be made by other mechanisms.

In a step 16 of FIG. 11, the handover procedure from NG-RAN node 1 to NG-RAN node 2 is indicated to 5GC for the UEs as indicated from AI/ML inferences (or the other mechanisms).

In a step 17 of FIG. 11, according to example embodiments, the 5GC indicates suspicious UEs from the list of UEs for which handover is being triggered to the target NG-RAN node 2.

In a step 18 of FIG. 11, according to example embodiments, the NG-RAN node 2 ignores the data from suspicious UEs for AI/ML model training and inferences.

As the AMF/Core is aware of UEs behaving malicious for a particular analytics/model (e.g. “analytics X”/“model X”), when such a UE freshly attaches to the gNB where the particular analytics/model (e.g. “analytics X”/“model X”) is running, according to example embodiments, the AMF informs the gNB to exclude the UE for the particular analytics/model (e.g. “analytics X”/“model X”).

According to further example embodiments, the NG-RAN node 2 exchanges the data pre-processor information with respect to the UE specific data validity. This pre-processor information needs to be exchanged via the core network (e.g. AMF). If the particular models exist in multiple NG-RAN nodes, then the data pre-processor can exchange the information about the UE specific training data validity and enhance the data pre-processor to detect the compromised UEs.

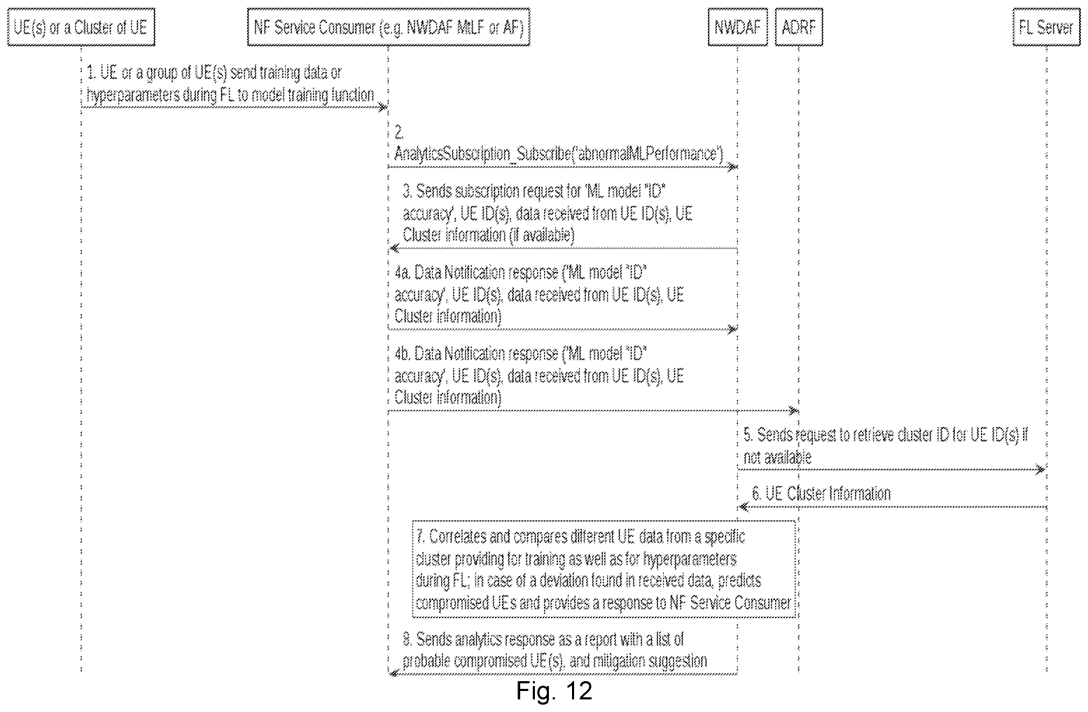

FIG. 12 shows a schematic diagram of signaling sequences according to example embodiments, and in particular illustrates an overview of a 5G core focused procedure according to example embodiments for a federated learning scenario.

In a step 1 of FIG. 12, an UE or a group of UE(s) shares the training data or hyperparameters during FL to the model training function.

In a step 2 of FIG. 12, a model training function (for instance NWDAF model training logical function (MtLF) or a third-party application function (AF)) constantly tracks the model performance and accuracy when receiving the UE(s) input either in the form of input data for training, or in the form of hyperparameters during FL model aggregation functionality According to example embodiments, the NF service consumer subscribes for the “abnormalMLperformance” analytics to NWDAF node.

In a step 3 of FIG. 12, according to example embodiments, the NWDAF sends a subscription request for “ML model ID accuracy, UE-IDs, data received from UE ID, UE cluster information” to the NF service consumer.

In a step 4a of FIG. 12, according to example embodiments, the NWDAF receives the data notification response with “ML model ID accuracy, UE-IDs, data received from UE ID, UE cluster information” from the NF service consumer.

Alternatively or in addition, in a step 4b of FIG. 12, according to example embodiments, the NF service consumer sends the same notification to ARDF.

In a step 5 of FIG. 12, according to example embodiments, the NWDAF sends a request to an FL server to retrieve a cluster ID for the UE ID if not available.

In a step 6 of FIG. 12, according to example embodiments, the FL server responds with UE cluster information.

In a step 7 of FIG. 12, according to example embodiments, the NWDAF correlates and compares different UE data from a specific cluster providing for ML training as well as the hyperparameters during FL. In case of a deviation found in the received data, the NWDAF predicts the compromised UEs and provides a response accordingly.

In a step 8 of FIG. 12, according to example embodiments, the NWDAF sends the analytics response as a report with a list of probable compromised UE(s) and mitigated suggestions.

It is noted that currently the FL happens between UE and a third-party AF, and the above explanation is primarily directed to such scenario. However, example embodiments as explained above are also applicable to deviating scenarios, e.g. when the FL happens in later releases between the UE and 5G Core NFs.

According to example embodiments, advantageously, compromised UEs attempting to send corrupt data towards AI/ML services can be detected, and input from such devices can be ignored. This can help eliminating any negative impacts of compromised UEs on AI/ML based network optimizations.

According to example embodiments, advantageously, if possible, such devices, i.e., compromised UEs attempting to send corrupt data towards AI/ML services, can be isolated.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network node or entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

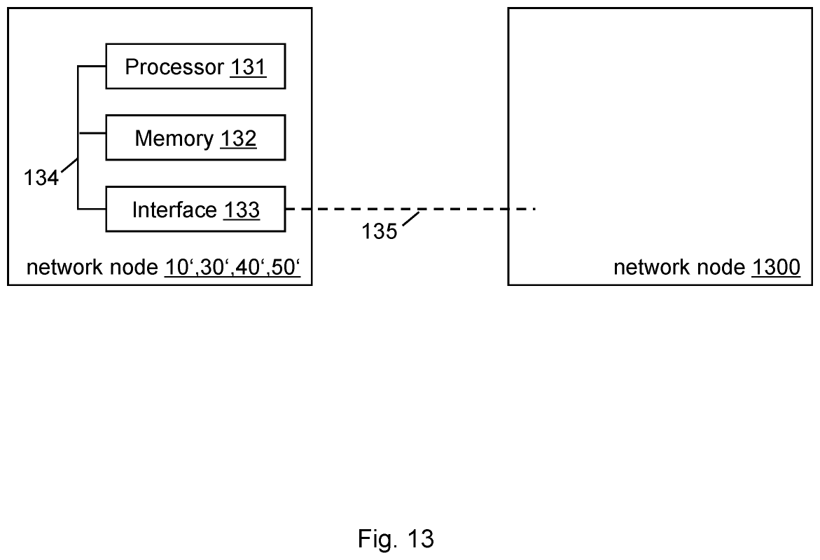

In FIG. 13, an alternative illustration of apparatuses according to example embodiments is depicted. As indicated in FIG. 13, according to example embodiments, the apparatus (network node) 10′, 30′, 40′, 50′ (corresponding to the network node 10, 30, 40, 50) comprises a processor 131, a memory 132 and an interface 133, which are connected by a bus 134 or the like. The apparatuses 10′, 30′, 40′, 50′ may be connected to another apparatus 1300 (an interface thereof) via link 135, respectively. According to example embodiments, the another apparatus 1300 may be another one of the apparatuses 10′, 30′, 50′.

The processor 131 and/or the interface 133 may also include a modem or the like to facilitate communication over a (hardwire or wireless) link, respectively. The interface 133 may include a suitable transceiver coupled to one or more antennas or communication means for (hardwire or wireless) communications with the linked or connected device(s), respectively. The interface 133 is generally configured to communicate with at least one other apparatus, i.e. the interface thereof.

The memory 132 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node or entity 10 comprises at least one processor 131, at least one memory 132 including computer program code, and at least one interface 133 configured for communication with at least another apparatus. The processor (i.e. the at least one processor 131, with the at least one memory 132 and the computer program code) is configured to perform receiving, from a first machine learning model training data collection entity, first machine learning model training input data (thus the apparatus comprising corresponding means for receiving), to perform analyzing said first machine learning model training input data for malicious input detection (thus the apparatus comprising corresponding means for analyzing), to perform deducing, based on a result of said analyzing, whether said first machine learning model training data collection entity is suspected to be compromised (thus the apparatus comprising corresponding means for deducing), and to perform transmitting, if said first machine learning model training data collection entity is suspected to be compromised, information to a core network entity indicative of that said first machine learning model training data collection entity is suspected to be compromised (thus the apparatus comprising corresponding means for transmitting).

According to example embodiments, an apparatus representing the network node or entity 30 comprises at least one processor 131, at least one memory 132 including computer program code, and at least one interface 133 configured for communication with at least another apparatus. The processor (i.e. the at least one processor 131, with the at least one memory 132 and the computer program code) is configured to perform receiving, from a first radio access network entity, information indicative of that a first machine learning model training data collection entity is suspected to be compromised (thus the apparatus comprising corresponding means for receiving), to perform receiving information indicative of that said first machine learning model training data collection entity is handed over towards a second radio access network entity, and to perform transmitting, to said second radio access network entity, information indicative of that said first machine learning model training data collection entity is suspected to be compromised (thus the apparatus comprising corresponding means for transmitting).

According to example embodiments, an apparatus representing the network node or entity comprises at least one processor 131, at least one memory 132 including computer program code, and at least one interface 133 configured for communication with at least another apparatus. The processor (i.e. the at least one processor 131, with the at least one memory 132 and the computer program code) is configured to perform receiving, from a plurality of machine learning model training data collection entities, machine learning model training input data and/or machine learning model hyperparameter data (thus the apparatus comprising corresponding means for receiving), to perform transmitting, towards an analytics service provider entity, a subscription request for malicious input detection analysis results (thus the apparatus comprising corresponding means for transmitting), to perform receiving, from said analytics service provider entity, a subscription request for machine learning model training related information, and to perform transmitting, towards said analytics service provider entity, said machine learning model training related information.

According to example embodiments, an apparatus representing the network node or entity comprises at least one processor 131, at least one memory 132 including computer program code, and at least one interface 133 configured for communication with at least another apparatus. The processor (i.e. the at least one processor 131, with the at least one memory 132 and the computer program code) is configured to perform receiving, from a machine learning model training entity, a subscription request for malicious input detection analysis results (thus the apparatus comprising corresponding means for receiving), to perform transmitting, to said machine learning model training entity, a subscription request for machine learning model training related information (thus the apparatus comprising corresponding means for transmitting), and to perform receiving, from said machine learning model training entity, said machine learning model training related information.

For further details regarding the operability/functionality of the individual apparatuses, reference is made to the above description in connection with any one of FIGS. 1 to 12, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for improved robustness of artificial intelligence or machine learning capabilities against compromised input. Such measures exemplarily comprise receiving, from a first machine learning model training data collection entity, first machine learning model training input data, analyzing said first machine learning model training input data for malicious input detection, deducing, based on a result of said analyzing, whether said first machine learning model training data collection entity is suspected to be compromised, and transmitting, if said first machine learning model training data collection entity is suspected to be compromised, information to a core network entity indicative of that said first machine learning model training data collection entity is suspected to be compromised.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP Third Generation Partnership Project
5G 5th Generation
AF application function
AI artificial intelligence
AMF access and mobility management function
FL federated learning
KPI key performance indicator
MDAS management data analytics service
MDT minimization of drive tests
ML machine learning
MtLF model training logical function
NF network function
NG next generation
NG-RAN next generation radio access network
NWDAF network data analytics function
OAM operations, administration and maintenance
QoE quality of experience
QoS quality of service
RAN radio access network
RAT radio access technology
RLF radio link failure
RRM radio resource management
RSRP reference signal received power
RSRQ reference signal received quality
SINR signal-to-noise and interference ratio
SUPI subscription permanent identifier
UE user equipment

1. An apparatus of a radio access network entity, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving, from a first machine learning model training data collection entity, first machine learning model training input data,
analyzing said first machine learning model training input data for malicious input detection,
deducing, based on a result of said analyzing, whether said first machine learning model training data collection entity is suspected to be compromised, and
transmitting, if said first machine learning model training data collection entity is suspected to be compromised, information to a core network entity indicative of that said first machine learning model training data collection entity is suspected to be compromised.

2. The apparatus according to claim 1, wherein
in relation to said analyzing, the at least one processor, with the at least one memory and the computer program code, is configured to cause the apparatus to perform:
applying an anomaly detection during machine learning model training data pre-processing of said first machine learning model training input data.

3. The apparatus according to claim 1, wherein
the at least one processor, with the at least one memory and the computer program code, is configured to cause the apparatus to perform:
receiving, from at least one second machine learning model training data collection entity, second machine learning model training input data.

4. The apparatus according to claim 3, wherein
in relation to said analyzing, the at least one processor, with the at least one memory and the computer program code, is configured to cause the apparatus to perform:
statistically correlating said first machine learning model training input data with said second machine learning model training input data to detect biases in said first machine learning model training input data.

5. The apparatus according to claim 1, wherein
the at least one processor, with the at least one memory and the computer program code, is configured to cause the apparatus to perform:
negotiating a handover decision for a third second machine learning model training data collection entity towards said radio access network entity,
receiving, from said core network entity, information indicative of that said third machine learning model training data collection entity is suspected to be compromised, and
setting to ignore third machine learning model training input data from said third machine learning model training data collection entity.

6. The apparatus according to claim 1, wherein the machine learning model training data collection entity comprises a user equipment, is a user equipment, or is comprised in a user equipment.

7. An apparatus of a core network entity, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving, from a first radio access network entity, information indicative of that a first machine learning model training data collection entity is suspected to be compromised,
receiving information indicative of that said first machine learning model training data collection entity is handed over towards a second radio access network entity, and
transmitting, to said second radio access network entity, information indicative of that said first machine learning model training data collection entity is suspected to be compromised.

8. The apparatus according to claim 7, wherein
the at least one processor, with the at least one memory and the computer program code, is configured to cause the apparatus to perform:
transmitting, towards a data storage entity, said information indicative of that said first machine learning model training data collection entity is suspected to be compromised.

9. The apparatus according to claim 7, wherein
the at least one processor, with the at least one memory and the computer program code, is configured to cause the apparatus to perform:
transmitting, towards a data analytics entity, a request to obtain an updated confidence value for said first machine learning model training data collection entity, and
receiving, from said data analytics entity, said updated confidence value for said first machine learning model training data collection entity.

10. The apparatus according to claim 7, wherein said first machine learning model training data collection entity comprises a user equipment, is a user equipment, or is comprised in a user equipment.

11. An apparatus of a machine learning model training entity, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving, from a plurality of machine learning model training data collection entities, machine learning model training input data and/or machine learning model hyperparameter data,
transmitting, towards an analytics service provider entity, a subscription request for malicious input detection analysis results,
receiving, from said analytics service provider entity, a subscription request for machine learning model training related information, and
transmitting, towards said analytics service provider entity, said machine learning model training related information.

12. The apparatus according to claim 11, wherein
said machine learning model training related information includes at least one of a machine learning model accuracy,
identifiers of said plurality of machine learning model training data collection entities,
said machine learning model training input data and/or machine learning model hyperparameter data, and
cluster information on a cluster formed by said plurality of machine learning model training data collection entities for federated learning.

13. The apparatus according to claim 11, wherein
the at least one processor, with the at least one memory and the computer program code, is configured to cause the apparatus to perform:
receiving, from said analytics service provider entity, said malicious input detection analysis results.

14. The apparatus according to claim 13, wherein
said malicious input detection analysis results include at least one of
machine learning model training data collection entities out of said plurality of machine learning model training data collection entities which are suspected to be compromised, and
a mitigation suggestion.

15. The apparatus according to claim 11, wherein
the machine learning model training data collection entity comprises a user equipment, is a user equipment, or is comprised in a user equipment, and/or
the machine learning model training entity comprises a network function service consumer, is a network function service consumer, or is comprised in a network function service consumer.

16. An apparatus of an analytics service provider entity, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving, from a machine learning model training entity, a subscription request for malicious input detection analysis results,
transmitting, to said machine learning model training entity, a subscription request for machine learning model training related information, and
receiving, from said machine learning model training entity, said machine learning model training related information.

17. The apparatus according to claim 16, wherein
said machine learning model training related information includes at least one of
a machine learning model accuracy,
identifiers of a plurality of machine learning model training data collection entities providing machine learning model training input data and/or machine learning model hyperparameter data to said machine learning model training entity,
said machine learning model training input data and/or machine learning model hyperparameter data, and
cluster information on a cluster formed by said plurality of machine learning model training data collection entities for federated learning.

18. The apparatus according to claim 16, wherein
the at least one processor, with the at least one memory and the computer program code, is configured to cause the apparatus to perform:
statistically correlating said machine learning model training input data and/or machine learning model hyperparameter data to detect deviations in said machine learning model training input data and/or machine learning model hyperparameter data.

19. The apparatus according to claim 18, wherein
the at least one processor, with the at least one memory and the computer program code, is configured to cause the apparatus to perform:
generating, based on said correlating, said malicious input detection analysis results, and
transmitting, to said machine learning model training entity, said malicious input detection analysis results.

20. The apparatus according to claim 19, wherein
said malicious input detection analysis results include at least one of
machine learning model training data collection entities out of said plurality of machine learning model training data collection entities which are suspected to be compromised, and
a mitigation suggestion.
